(19) United States
(12) Patent Application Publication
(10) Pub. No.: US 2014/0196963 A1
(43) Pub. Date: Jul. 17, 2014

(54) DEVICE FOR ATTACHING A POWER PLANT TO A CHASSIS OF A MOTOR VEHICLE

(71) Applicant: Jean-Luc Salomons, Sannois (FR)

(72) Inventor: Jean-Luc Salomons, Sannois (FR)

(73) Assignee: RENAULT s.a.s., Boulogne Billancourt (FR)

(21) Appl. No.: 14/235,689

(22) PCT Filed: Jun. 21, 2012
(86) PCT No.: PCT/FR12/51414

§ 371 Date: Feb. 7, 2014

(30) Foreign Application Priority Data
Jul. 29, 2011 (FR) 11 56982

(51) Int. Cl. B60K 5/12

(52) U.S. Cl. CPC B60K 5/12
USPC 180/54.1; 248/674; 29/426.2

(57) ABSTRACT

A device for attaching a power plant to a chassis of a motor vehicle, the device including a body including a first end configured to be connected to a first attachment element belonging to the power plant and a second end configured to be connected to a second attachment element belonging to the chassis.

The present invention relates to a device for attaching a power plant to a chassis of a motor vehicle. The invention relates also to an assembly comprising such an attachment device. The invention also relates to a method of modifying the attachment of a power plant to a chassis of a motor vehicle.

For certain after-sales service or maintenance operations, it is important to be able to move the power plant relative to the chassis without in any way needing to disconnect the various connections (the circuit for the water, fuel, air-conditioning, etc.). That is of particular benefit when carrying out interventions on the top of the power plant (changing the alternator, a compressor, etc.) in a shorter length of time. The power plant has in fact to be able to operate in its altered position so that checks can be performed prior to reassembly.

It is an object of the invention to provide an attachment device that provides a solution to the abovementioned problem and improves the known attachment devices of the prior art. In particular, the invention proposes an attachment device that is simple, allowing a power plant to be moved relative to a chassis to make maintenance operations easier. The invention also relates to a method for modifying an attachment of a power plant to a chassis.

According to the invention, a device for attaching a power plant to a chassis of a motor vehicle comprises a body a first end of which is intended to be connected to a first attachment element of the power plant and a second end of which is intended to be connected to a second attachment element of the chassis.

The attachment device may have a shape that is elongate along an axis.

The attachment device may measure between around 10 centimeters and around 20 centimeters, notably around 15 centimeters.

The attachment device may comprise a radial slot at the first end or at the second end.

The attachment device may comprise a first tapping at the second end to accept a first threaded attachment element that collaborates with the second attachment element of the chassis.

The attachment device may comprise a second tapping to accept a second threaded attachment element secured to the power plant.

The first and second tappings may be coincident.

According to the invention, an assembly comprises an attachment device defined hereinabove and a screw intended to be screwed into the attachment device.

According to the invention, the method of modifying the attachment comprises the following steps:
disconnecting the power plant from the chassis,
moving, notably lowering, the power plant relative to the chassis,
supplying an attachment device, notably an attachment device as defined hereinabove,
attaching the power plant to the chassis via the attachment device.

The step of attaching the power plant to the chassis using the attachment device may comprise a step of attaching, notably of screwing, the attachment device to an attachment element of the power plant or of the chassis, notably to a stud of the attachment element of the power plant or of the chassis.

The step of attaching the attachment device to an attachment element of the power plant may comprise a step of fitting the attachment device by moving it in a direction parallel or substantially parallel to the direction in which the power plant is moved relative to the chassis.

The step of attaching the power plant to the chassis using the attachment device may comprise a step of attaching, notably of screwing, the attachment device to an attachment element of the chassis or to an attachment element of the power plant, notably using a fixing screw.

The method may then comprise a step of removing the attachment device and a step of attaching the power plant to the chassis without the attachment device.

According to the invention, a motor vehicle is obtained using the method defined hereinabove.

The attached drawing depicts, by way of example, one embodiment of an attachment device according to the invention.

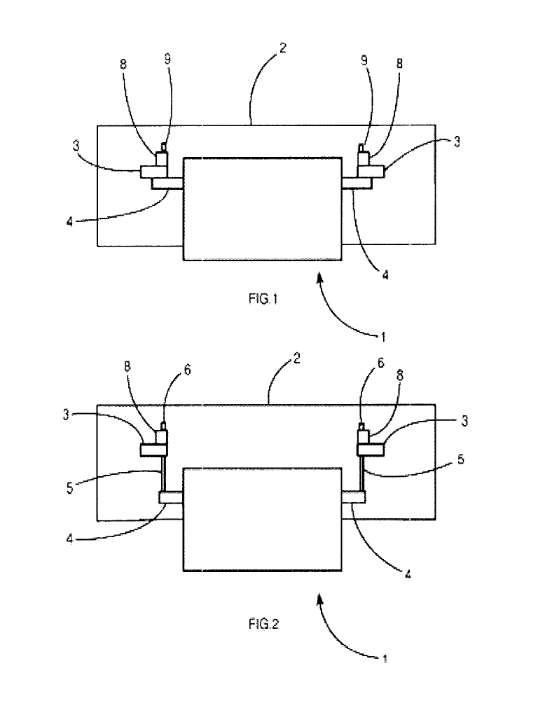

FIG. 1 is a view of a power plant mounted on a chassis of a motor vehicle in a first configuration.

FIG. 2 is a view of the power plant mounted on the chassis of a motor vehicle in a second configuration using one embodiment of an attachment device according to the invention.

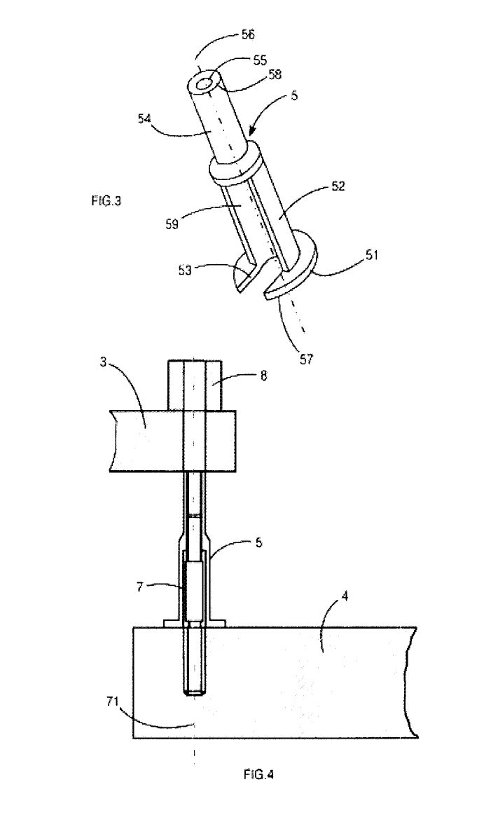

FIG. 3 is a perspective view of the embodiment of the attachment device according to the invention.

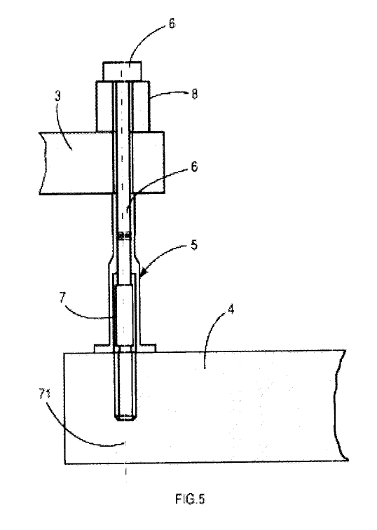

FIG. 4 is a detailed view, in the second configuration, of the embodiment of the attachment device according to the invention, fitted to a power plant before being attached to the chassis.

FIG. 5 is a detailed view, in the second configuration, of the embodiment of the attachment device according to the invention, fitted between a power plant and a chassis, the power plant being attached to the chassis using the attachment device.

FIG. 1 depicts part of a motor vehicle. The vehicle comprises a chassis 2 and a power plant 1. The power plant for example comprises an internal combustion engine. However, it could equally comprise an electric motor.

The power plant is attached to the chassis using attachment elements 3 of the chassis which are provided on the chassis, such as arms or lugs, that collaborate with attachment elements 4 of the power plant, such as arms or lugs. For example, studs 7 are fitted at the end of the attachment elements of the power plant. Once the power plant has been positioned relative to the chassis, these studs pass through the end of the attachment elements of the chassis and nuts 9 are fitted to the studs. For preference, the studs pass through the attachment elements of the chassis in the region of shock absorbing elements 8, such as silent blocks, so as to provide maximum vibrational uncoupling between the power plant and the chassis. Of course, the attachment could be reversed. Notably, the studs could be fitted to the attachment elements of the chassis to collaborate with through-holes made in the attachment elements of the power plant.

For example, use is made of two attachment elements of the chassis collaborating with two attachment elements of the power plant in order to attach the power plant to or suspend it from the chassis. However, it is of course possible to use more than two attachment elements of the chassis collaborating with more than two attachment elements of the power plant.

In FIG. 1, the power plant is in a first configuration characterized by a first position of the power plant relative to the chassis.

As mentioned earlier, in this first position, certain maintenance or after-sales service operations are tricky if not impossible. It is therefore necessary to dismantle the power plant from the chassis in order to make certain operations easier, or even to make them possible. In order to allow the power plant to operate when it is not in the first position described hereinabove, use is made of the attachment devices that form the subject matter of the invention.

Specifically, the attachment devices according to the invention provide a mechanical attachment interface between the attachment elements of the power plant and the attachment elements of the chassis so that the power plant is attached to the chassis in a second configuration characterized by a second position of the power plant relative to the chassis.

To create this interface, a first end of each attachment device is attached to The attachment elements of the power plant and a second end of each attachment device is attached to the attachment elements of the chassis. This then results in the second configuration depicted in FIGS. 2 and 5. FIG. 4 depicts the same second configuration prior to the attaching of the attachment devices to the attachment elements of the chassis.

Thus, the attachment device 5 allows the power plant 1 to be attached to the chassis 2 of the motor vehicle in the second configuration. The attachment device comprises a body a first end 57 of which is intended to be connected or attached to a first attachment element 4 of the power plant and a second end 58 of which is intended to be connected or attached to a second attachment element 3 of the chassis. Nevertheless, outside of after-sales service or maintenance operations, it is clear that the first attachment element of the power plant is attached to the second attachment element of the chassis directly or, at least, without the use of the attachment device 5, such that the power plant is attached to the chassis in the first configuration.

In one embodiment depicted in FIG. 3, the attachment device has a shape that is elongate along an axis 56. For example, it measures between 10 cm and 20 cm, notably around 15 cm.

The attachment device has, for example, an overall shape that exhibits symmetry of revolution. It consists of a bored first part 52 extending from its first end 57 and a tapped second part 54 extending from its second end 58. Its first end 57 comprises a face 51 intended to bear against the attachment element of the power plant. At its second end 58, the attachment device comprises a tapping 55, for example an M10 tapping, along the axis 56. Moreover, the first part comprises a slot 53 or a groove extending radially from the axis 56. As will be described later on, this slot allows the axis 56 of the attachment device to be made to coincide with the axis 71 of a stud 7 by moving the attachment device essentially perpendicular to its axis 56. The height of the aperture measured along the axis 56 is nonetheless shorter than the height of the stud 7 measured along the axis 71, so that the threaded end of the stud can be screwed into the tapping 55.

The tapping is able to accommodate a first threaded attachment element 6, such as a screw collaborating with the second attachment element of the chassis. The first threaded element passes for example through a hole made in the second attachment element of the chassis. It may also be able to accept a second threaded attachment element, such as a stud 7, secured to the power plant. Alternatively, two tappings may be provided to accept the first and second threaded elements.

The attachment device 5 together with the threaded element 6 constitutes an attachment assembly.

One embodiment of a method of modifying the attachment of a power plant to a chassis of a motor vehicle is described hereinafter. This modification allows a power plant to be moved from the first configuration into the second configuration. To do that, the way in which the power plant is suspended relative to the chassis is altered.

Thus, in a first step, a lifting platform is brought in under the power plant and the power plant is disconnected from the chassis at the attachments mentioned hereinabove. With the chassis resting on a vehicle lift, it is moved, for example raised, by 15 cm for example.

In a second step, attachment devices 5 are supplied and fitted. In the example depicted, the axis 56 of the attachment device and the axis 71 of a stud 7 are brought into coincidence and the end of the tapping 55 in the bottom of the bore 59 is brought into contact with the end of the stud 7 by moving the attachment device essentially perpendicular to its axis 56. Specifically, because of the presence of an attachment element of the chassis, it is not possible to fit the attachment device by moving the attachment device essentially parallel to its axis 56 in order to bring the end of the tapping 55 in the bottom of the bore 59 into contact with the end of the stud 7. The attachment devices are then screwed onto the studs until the surfaces 51 come into contact with the attachment elements of the power plant.

In a third step, the power plant is attached to the chassis via the attachment device. To do that, screws 6 are supplied and fitted in holes made in the attachment elements of the chassis (holes that are normally occupied by the studs 7). Next, these screws 6 are screwed into the tappings 55 as depicted in FIG. 5. Thus, the attachment devices find themselves interposed between the attachment elements of the power plant and the attachment elements of the chassis. They allow the power plant to be attached in its second configuration. Specifically, power plant retention or suspension loadings pass from the studs 7 to the attachment devices, then to the screws 6, then to the attachment elements of the chassis.

The power plant is therefore suspended from the chassis using the attachment device which acts as an extension piece.

As a result, maintenance or after-sales service operations can be carried out on the power plant. The power plant can even be made to operate if need be while it is in its second configuration in order to check that everything is functioning correctly before the power plant is returned to its first configuration by performing the reverse of the operations described above.

Once these checks have been made and the power plant has been reconfigured in its first configuration, the motor vehicle can be handed back to its owner.

For preference, use is made of attachment devices of a length of around 15 cm.

As seen hereinabove, the use of a slot 53 makes it possible to limit the movements of the chassis relative to the engine when changing from the first configuration to the second configuration. In addition, it makes it possible to avoid damage to the threaded part of the studs of the attachment elements of the power plant.

1-14. (canceled)

15. A device for attaching a power plant to a chassis of a motor vehicle, the device comprising:
a body including a first end configured to be connected to a first attachment element of the power plant and a second end configured to be connected to a second attachment element of the chassis.

16. The device as claimed in claim 15, having a shape that is elongate along an axis.

17. The device as claimed in claim 15, measuring between around 10 centimeters and around 20 centimeters, or around 15 centimeters.

18. The device as claimed in claim 15, further comprising a radial slot at the first end or at the second end.

19. The device as claimed in claim 15, further comprising a first tapping at the second end to accept a first threaded attachment element that collaborates with the second attachment element of the chassis.

20. The device as claimed in claim 19, further comprising a second tapping to accept a second threaded attachment element secured to the power plant.

21. The device as claimed in claim 20, wherein the first and second tappings are coincident.

22. An assembly comprising:
an attachment device as claimed in claim 15; and
a screw configured to be screwed into the attachment device.

23. A method of modifying attachment of a power plant to a chassis of a motor vehicle, comprising:
disconnecting the power plant from the chassis;
moving, or lowering, the power plant relative to the chassis;
supplying an attachment device as claimed in claim 15;
attaching the power plant to the chassis via the attachment device.

24. The method as claimed in claim 23, wherein the attaching the power plant to the chassis using the attachment device comprises attaching, or screwing, the attachment device to an attachment element of the power plant or of the chassis, or to a stud of the attachment element of the power plant or of the chassis.

25. The method as claimed in claim 23, wherein the attaching the attachment device to an attachment element of the power plant comprises fitting the attachment device by moving it in a direction parallel or substantially parallel to a direction in which the power plant is moved relative to the chassis.

26. The method as claimed in claim 23, wherein the attaching the power plant to the chassis using the attachment device comprises attaching, or screwing, the attachment device to an attachment element of the chassis or to an attachment element of the power plant, or using a fixing screw.

27. The method as claimed in claim 23, further comprising removing the attachment device and attaching the power plant to the chassis without the attachment device.

28. A motor vehicle obtained using the method as claimed in claim 27.
